(19) United States
(12) Patent Application Publication
(10) Pub. No.: US 2008/0214271 A1
(43) Pub. Date: Sep. 4, 2008

(54) Electronic game card

(76) Inventor: Mattias Rydberg, Varmdo (SE)

Correspondence Address: HARNESS, DICKEY & PIERCE, P.L.C., P.O. BOX 8910, RESTON, VA, 20195, US

(21) Appl. No.: 12/071,644

(22) Filed: Feb. 25, 2008

Related U.S. Application Data
(63) Continuation-in-part of application No. 11/523,768, filed on Sep. 20, 2006.

(51) Int. Cl. A63F 9/24; G06F 19/00

(52) U.S. Cl. 463/17; 463/44; 463/31

(57) ABSTRACT

An electronic game card and a method are disclosed for playing an instant lottery game which may provide a novel game experience as well as a game card which is cost effective to produce. In at least one embodiment, the game card includes a control chip, a start button, a random value generator and a display, which are each arranged on a flexible support of the game card, and the outcome of the lottery game is determined by said random number generator.

### PRIORITY STATEMENT

The present application is a continuation-in-part of and hereby claims priority under 35 U.S.C. §120 on U.S. patent application Ser. No. 11/523,768 filed Sep. 20, 2006, the entire contents of which is hereby incorporated herein by reference.

### TECHNICAL FIELD

The invention relates to the field of electronic game cards, and more specifically, relates a device and a method for electronic game cards intended for use in instant lottery games, and even more specifically relates to disposable electronic game cards.

### BACKGROUND

An important part of the game industry relates to instant lottery games using paper lottery tickets. These tickets are provided with play areas comprising several symbols or characters, which are covered with an opaque material such as latex. To play the game a player scratches off the latex from at least some of the play areas, and the uncovered symbols or characters printed on the ticket determines whether the game was successful or not.

In order to meet the competition from other game providers, such as casinos and internet operators, instant lottery game providers must constantly offer new type of games. WO 2005/055153 describes an electronic game device which is targeted at the traditional paper lottery ticket market. A disadvantage related to this game device is that it is relatively costly to manufacture, and limited with respect to the type of games it is able to provide.

### SUMMARY

One object of the invention is to provide an electronic lottery ticket which eliminate or at least alleviate the above mentioned problem. An alternative object is aimed at providing a new type of instant lottery game which offers the player a novel game experience.

According to a first aspect thereof, the present invention provides an electronic game card which comprises a control device with processing capabilities for controlling a game, and a start device for activating the game. Further, said game card comprises a random value generator for generating a random data which determines the outcome of the game, as well as a display device for visually indicating the outcome of the game. The start device, the random value generator and the display device are each operably connected to said control device and are each arranged on or carried by the same flexible support, which is made of a material selected from a group comprising paper, plastic and combinations thereof.

According to a second aspect thereof, the present invention relates to a method of operating an electronic game card, comprising a flexible support made of a material selected from the group comprising paper, plastic and combinations thereof. The method comprises the steps of: activating a control device having processing capabilities for controlling a game, which control device is carried by a support of said game device; generating random data by means of a random data generator carried by a support of said game device; transmitting said generated random data to said control device; determining at said control device, whether said data corresponds to a successful game; displaying by means of a display device, carried by said game card, the result of said determination.

According to a third aspect thereof, the present invention relates to a method of operating an electronic game card, comprising a flexible support made of a material selected from the group comprising paper, plastic and combinations thereof. Said method comprises the steps of activating a control device having processing capabilities for controlling a game, which control device is carried by a support of said game device; generating a group of random data by means of a random data generator carried by a support of said game device, which group of data represent successful outcomes of a game; providing said control device with result data representing an outcome of the game and said group of random data; determining, at said control device, whether the outcome of the game is successful by comparing said result data to said group of random data; displaying by means of a display device, carried by a support of said game card, the result of said determination.

Advantageously, in order to reduce manufacturing costs, the electronic game card is preferably fully, or to a great extent, produced using materials which enables low cost production methods, such as high speed reel-toreel printing techniques. One example of this type of material is electric circuits comprising thin films or layers of electrically conductive polymers.

The support is preferably a sheet comprising paper or plastic, for example a sheet of cardboard having a thickness of normally less than 2 mm, preferably less than 1 mm and more preferably less than 0.5 mm. Moreover, the support is preferably self supported or self contained, such that there is little need to provide a separate container in order to support or protect the game card. This enables the manufacture of cheaper electronic game cards. According to one embodiment said electronic game card comprises a layer of transparent or semi-transparent laminate in order to protect the game card.

The total thickness of the game card device is preferably less than 2 mm and even more preferred less than 1 mm. The area of the game card is preferably less than 0.1 m², and even more preferred less than 0.05 m².

In relation to this invention the term “flexible” refers to something which can be bent or deformed at least to some degree without breaking, i.e. without loosing its ability to substantially retake its original flexibility, shape and function. As a comparison, a book page has normally a high degree of flexibility—it can be bent and rolled, but usually not folded, without irreversibly losing its flexibility. A typical credit card is also flexible although more rigid; it is possible to deform it by bending, but it will normally break if a sufficiently strong bending force is applied to it. Hence, according to one embodiment of the invention the support has a rigidity corresponding to that of a typical credit card, in order to prevent the user from damage e.g. the display of the game card by accidentally folding the card. In other words the support may be made of a sheet of polyethylene which is less than 1 mm thick, and preferably less than 0.2 mm thick.

In relation to this invention a first device i.e. a control device, is operably connected to a second device i.e. a display device, when said first device is able to transmit signals which is received and reacted to by said second device.

For known instant lottery games, such as conventional paper lottery tickets or the game device described in WO 2005/055153, the outcome of the game is already determined when the game is manufactured. For conventional paper lottery tickets this is done when the characters or symbols are printed on the ticket, and for the game device of WO 2005/055153 it is done by the configuration of the ports of the chip to the circuit board of the card.

For a game card in accordance with the present invention a random data generator or a random value generator is used for determining the outcome of the game. In other words, the outcome of the game is not predetermined at the sale of the game card, but determined after the game has been activated and the random generator generates a random value. According to one embodiment the random value or random data is forwarded to the control device, in order for it to determine if the game is successful or not. The generated value is compared to a predetermined setting of the game card, such as a register or a list. According to one example the random value generator is able to provide a uniform distribution of any number between 0 and 9,999. Moreover, the predetermined setting of the game card states e.g. that if the random value generator provides a number equal to 1, the result of the game corresponds to the best award, and if the provided number is between 2 and 5, the result of the game corresponds to the second best award and so on. Consequently, the random number generator in combination with the settings for determining a successful game ensures that the distribution of successful outcomes which should be rewarded follows, at least over time, a desired statistical pattern. Normally, the game card provides a limited round of games which can be played.

Due to the random number generator, normally each game card in a series of game cards is equally likely to generate the top prize, irrespectively if this prize has yet been generated by another game card or not. Hence, the player's game experience is substantially different compared to traditional lottery games. Thus, the customer's interest for the game will most likely last longer, and a headline declaring that the top prize has been won is in fact, in contrast to the situation for traditional lottery games, likely to attract more players to the same game series. Additionally, according to one embodiment of the game card each time the game is played is equally likely to be successful, i.e. generate an award.

According to one embodiment of the invention, all game cards in a series of game cards are made fully identical, and the random number generator provides for a desired statistical distribution of successful game cards and their respective awards. This is advantageous as it facilitates keeping manufacturing and management costs to a minimum, by eliminating the need for individual programming of the game cards. In other words, the possibility of making all game cards fully identical facilitates the handling of the lottery game, as there is no longer a need for producing individually different lottery tickets or game cards comprising individually different game settings.

Preferably, the random value generator is a pseudorandom value generator, generating e.g. a uniform or normal distribution of random data.

The display is preferably made of a flexible material, in order to facilitate an adjustment of the display to a slight deformation or bending of the support. According to a preferred embodiment, the display is based on rotation of dichroic dipoles, wherein anisotropic particles are rotated in response to an applied electric field. According to another preferred embodiment the display is an electrophoresis display, wherein charged particles comprised in a liquid are rotated in response to an applied electric field. According to a most preferred embodiment, the display is an electrochromic display comprising electrically conducting polymers and electrolyte.

According to a one embodiment of the invention the display device comprises one or several display element, wherein each display element is able to generate one color. Preferably, two different display elements are used, such that the display is able to visually display at least two different colors. In this context the term color refers to a wavelength interval. In other word, a display comprising a first display element able to emit blue light, and a second display element able to emit white light, is in the context of this invention referred to as being able to generate only two colors (blue and white) despite all the shades of light blue which can be perceived by the human eye as a response to wavelength generated using a combination and different intensities of these display elements.

The display elements are preferably formed of freely formed layers, which can be given a wide variety of at least two dimensional geometric shapes, such as circular, pie-shaped etc, as this facilitates giving the display device substantially any desired geometric shape.

According to one embodiment of the invention, the display is arranged such that it is able to graphically illustrate the progress of the game, by means of for example an animation or a series of pictures. The display might for example be able to illustrate a spinning wheel of fortune, or a roulette table. A graphical illustration advantageously makes the game more appealing to the player. A display of merely a set of alphanumeric characters is in the context of this invention not regarded as a graphical illustration.

According to one embodiment of the invention the control device may be embodied in the form of a microprocessor and an accompanying memory or an integrated circuit such as an ASIC or an FPGA, and preferably CMOS circuits with flash or EPROM. There are several manufactures who provide these type of chips, having a preferred thickness of about 0.2 μm to about 0.6 μm. The steps comprised in the method defined by the present invention may be implemented in software executed on the microprocessor.

According to one embodiment of the invention the electronic game card further comprises a power source, such as a solar cell or a battery arranged on said support. In other words, the game card comprises an integrated power source. The battery is preferably a Leclanchébattery, or a battery based on Manganese dioxide and Zinc, as such batteries are relatively harmless to the environment and can be made thin and flexible at a low cost. A flexible battery is in context of this invention a battery which can adjust to a small deformation or bending of the support. Alternatively, the power source may e.g. be a battery based on e.g. lithium.

According to another embodiment of the invention the electronic game card is provided with means for connecting said control device to an external power source, such as the battery of a cellular phone or other suitable power devices. A game card according to the invention may also be provided with both an integrated power source as well as an external power source.

According to one embodiment of the invention the electronic game card is provided with interaction means or an input device arranged to receive input from the player regarding actions the player wants to take when playing the game. These interaction means are for example buttons or sensors which the player can use to indicate his actions, such as placing a bet or informing the game regarding which symbol(s) or play area(s) the player thinks is/are the successful one(s). The interactions means are further arranged to forward information about the player's actions to the control device. This information may contain betting information, i.e. information regarding e.g. how much the player wants to bet on a specific outcome, and/or information regarding which number or color the player thinks will be successful.

Preferably, the game card provides an instant lottery game, i.e. a game where the game card at the end of a game session displays the outcome of the game. In other words the player does not have to wait for a list of winning tickets to be published in e.g. a news paper. According to one embodiment of the invention, the game cards provides a probability game, i.e. a game wherein the player has to make a successful selection. For example, choose the door behind which he thinks a prize is hidden.

According to one embodiment of the invention said game card is preferably a disposable game ticket, in other words the game card is not intended to be reloaded with additional games when the first one(s) has/have been played.

According to one embodiment the game card further comprises a loud speaker which may be arranged for announcing events in the game, or for providing background music.

According to one embodiment of the invention a value generated by said random value generator is used for encrypting the result of the game. In order to enhance security of the electronic game card, and prevent manipulation of the result, the outcome of the game or a code related to the outcome of the game is encrypted using data generated by said random data generator. Before an award is given to the holder of the game card, said encryption is decoded and the code or outcome is verified, by the awarding organization. Advantageously, this facilitates the verification of the game card.

### BRIEF DESCRIPTION OF DRAWINGS

Specific embodiments of the invention will now be described, by way of example, with reference to the accompanying drawings.

FIG. 1 schematically illustrates one embodiment of an electronic game card according to the invention implementing a simplified game of roulette.

FIGS. 2a and 2b schematically illustrates a second embodiment of an electronic game card according to the invention implementing a probability game.

FIG. 3 schematically illustrates the interaction between different devices which are preferably arranged on said game card.

FIG. 4 schematically illustrates a third embodiment of an electronic game card according to the invention.

### DESCRIPTION OF EXAMPLE EMBODIMENTS

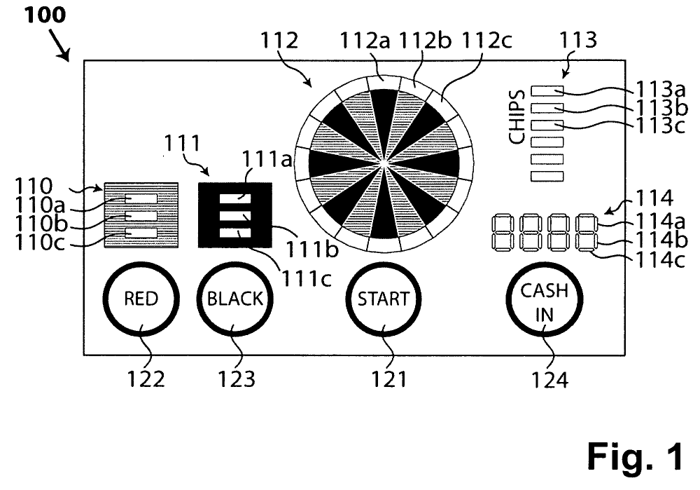

FIG. 1 schematically illustrates one embodiment of an electronic game card 100 according to the invention. The game card support is about e.g. 15 cm wide, about 10 cm high, about 0.5 mm thick and made of cardboard. Arranged on the support are a number of display devices 110-114 in order to provide the user with information regarding the status of the game. Each of these display devices comprises several display fields 110a-c; 111a-c; 112a-c, 113a-c; 114a-c which can be turned on and off, individually, e.g. by the application of an electric voltage as is known in the art. The display device can be of many different types as described herein, but is preferably formed of a material which provides a substantial degree of geometrical freedom when shaping the display, such that e.g. the differently colored segments 112a-c of the roulette wheel can be formed. One example of such a material comprises thin films of inherently conductive polymers.

The electronic game card 100 is also provided with a start device 121, by which the user or player activates the game card. In this embodiment the start device is a button, which is operably connected to a control device (not shown) with processing capabilities for controlling the game.

The electronic game card may have a layered structure, wherein a top sheet of preferably non-transparent cardboard or plastic is arranged on top of the displays devices and buttons, such that these components are arranged between the support and said top sheet. Said top sheet is preferably provided with transparent areas or openings, such that said displays can be viewed through the top sheet. Further, instructions and graphics are preferably but not necessarily printed on said top sheet before said sheet is arranged on top of said components.

According to an alternative embodiment, at least one display device is arranged on a first side of the support and one or all of the other components, e.g. the control device and the random number generator, are arranged on the other or second side of the support. In this way, some of the components can be hidden from the user at the back side of the support. In this embodiment preferably both sides of the support are covered by a protective layer.

As the player presses the start device 121, one display device 113 indicates the available number of casino chips or counters, and the display fields of two display devices 111,112 start to flash to encourage the player to place a bet, i.e. predict which color he thinks will be successful. The bet is placed by activating one of the two interaction devices 122, 123 below the display devices 110,111, such that a desired amount for the bet is selected. According to this embodiment the interaction devices are buttons. Thereafter, the player presses the start button 121 again and the roulette wheel 112 starts spinning, i.e. the circle segments 112a-c are lit one at a time in a consecutive and clock-wise order, until it stops or freezes. It is the control device which determines at which circle segment the roulette wheel is to stop, based on a value generated by a random value generator which is arranged on the support (not shown).

Once the wheel stops, the result of the game is computed by the control device and displayed in the result display device 114. As long as the player has more chips or counters available, as displayed by the result display device 113, he can place a new bet by using the interaction devices 122,123 and spin the wheel by pressing the start device 121.

Alternatively, the player can end the game by pressing the cash device 124, upon which the game result is converted by the control device into amount of money, which is displayed in the cash display device 114, and which amount can be collected at e.g. certified counters.

Advantageously, the game card also generates a verification code, which is preferably encrypted using a unique data, such as a random data generated by said random data generator. This code is preferably decrypted and verified before any money is awarded a winning game card.

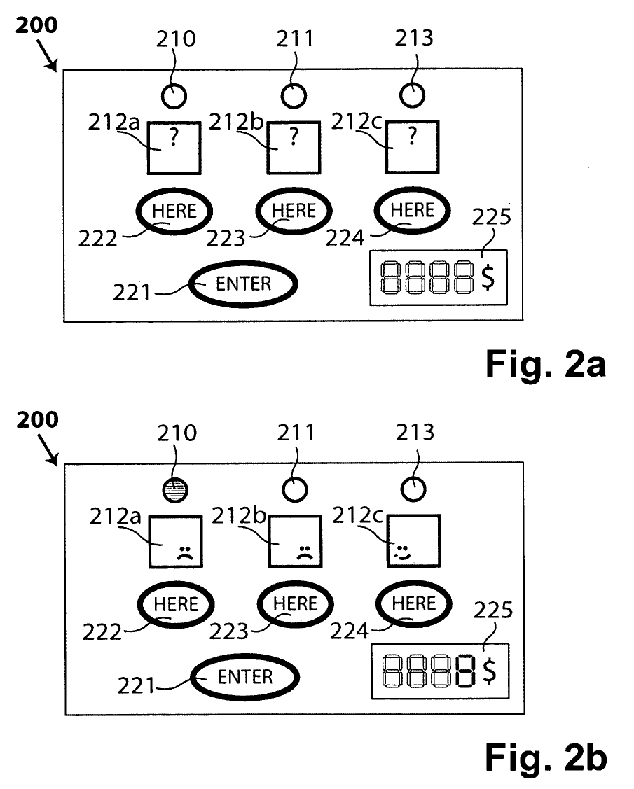

Although a simplified game of roulette has been described above, other types of games can be implemented on the electronic game card, using suitable software, display and interaction devices. One example of such a game is a probability game schematically described in FIGS. 2a and 2b. The electronic game card is arranged as described in relation to FIG. 1, except that there are according to this embodiment three larger display devices 212a-c, three interaction devices 222-234, and three smaller display devices 210, 211, 213. The game is initiated when the player removes a plastic strip form the back side of the electronic game card, which connects the battery to the circuitry of the game card. The player begins by selecting which display device he thinks will be successful by pressing the corresponding interaction device or button, in this example he selects the left most display, and the corresponding smaller display is lit 210. In order to confirm his choice he presses the start device, i.e. the button marked “Enter”. Thereafter, in this example, the middle display is switched such that it indicates the successful display is either the one to the left or the one to the right. An unsuccessful choice of display can be indicated by the display being turned of, or by it displaying a corresponding sign or color, e.g. a cross, red or a sad face. Now, the player can reconfirm his choice or switch to the right most display—if he has changed his mind and thinks that display is the successful one, an there after press “Enter”. FIG. 2b, the result is displayed, in this example the right most display was the successful one. If the player has selected a successful display, the award will be indicated in the cash display device 225 as described in relation to FIG. 1.

According to another example the game is based on the fruit machine principle. In this game the player makes no prediction before the first random value is generated, after the game card has been activated. This value is compared to an internal register in order to determine if it is a successful number or not, i.e. if it corresponds to a win. The result may be displayed as a combination of symbols, e.g. fruits, or as a symbol representing an amount of money or a symbol corresponding to success. Preferably, said random data generation in combination with said internal register is arranged such that a desired distribution of the successful numbers with respect to the probability to win is achieved. According to one example the random number generator provides a uniform distribution of generated values. Moreover, according to said register two of the numbers, e.g. 1 and 2 represents the highest win; 9 of the remaining numbers e.g. 20-29 represents the second highest win; 38 of the remaining numbers represents the third highest win, 31-33, 37-47, 51-74 etc.

Alternatively, before the first win is determined, the random number generator is used to establish the content of the internal register. In other words, a first group of generated random numbers corresponds to the highest win, e.g. number 2183 and 7582; a second group of random numbers corresponds to the second highest win, e.g. number 5047, 4328, 0478, 0512, 2746, 3804, 0809, 6774, 3749 etc. A register generated in this way is referred to as a random internal register. Wherein each group of numbers comprises at least one number. A randomly generated outcome of the game might be used in combination with said random internal register.

Alternatively, when the internal register is established using the random number generator, the value representing the outcome of the game might be predetermined or preprogrammed, instead of generated using said random number generator.

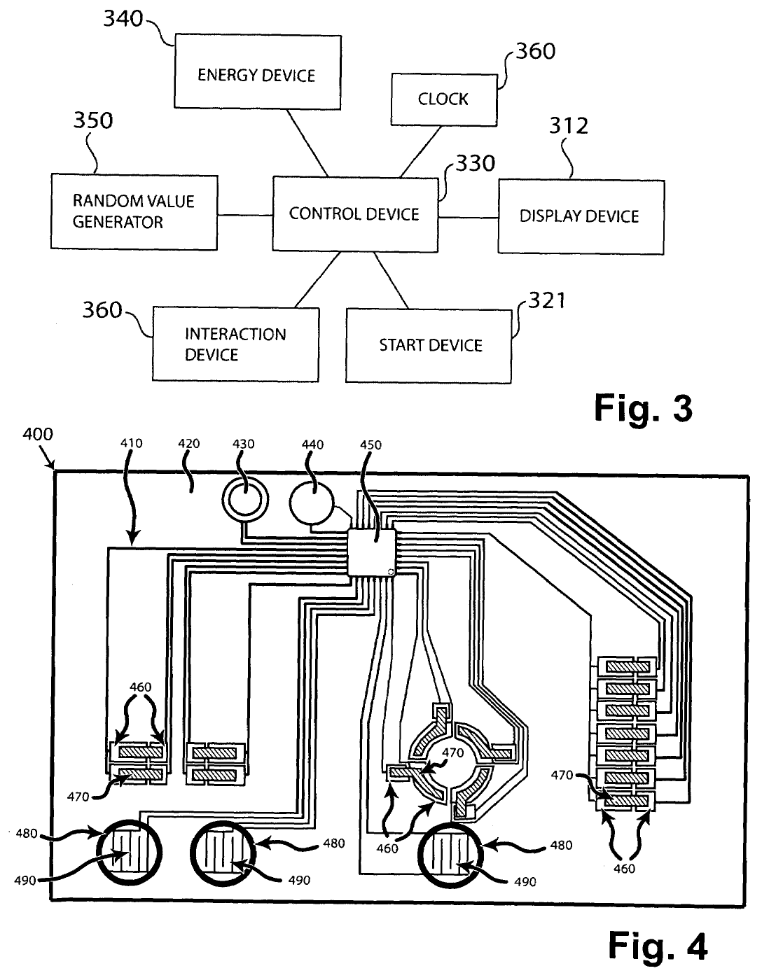

FIG. 3 schematically illustrates one example of an electronic game card architecture. The structure of the game card and the communication between the different devices of the electronic game card is only briefly discussed, since the person skilled in the art readily knows how to achieve e.g. such a behavior of the electronic game card as was described in relation to FIG. 1, based on what has been described herein and using e.g. normal programming skills. Although the devices are illustrated in separate boxes, one or more of the devices can be implemented in the same physical unit.

When the start device 321 is activated for the first time it sends an activation signal or message to said control device 330, which in turn sends initiating display information to the at least one display device 312 such that it will display information which indicates that the game is ready to be played. Alternatively, the connecting of the energy source 340 to the electronic game card sends an activation signal to said control device. The connection of the energy source can for example be made by removing a slip, which isolates a battery from the rest of the circuitry.

The random data generator 350b is used to generate a random data which determines the outcome of the game, as described above. This data is transmitted to said control device 330. Preferably, said game card is also provided with interaction devices 360, such as buttons or other types of control means. Moreover, said game card is preferably arranged with the some type of energy providing means, such as a battery or a solar cell.

There are a number of techniques available for producing cost effective displays, as indicated in the table below. The presented techniques are all suitable for producing thin, flexible displays.

| | CATEGORY | GENERAL PRINCIPLE | TYPES |
|---|---|---|---|
| DISPLAY | Magnetism | Orientation of magnetic | Dichroic magnetic parti- |
| TECHNOLOGIES | | particles under an applied | cles |
| BASED ON NON- | | magnetic field | Elongated magnetic parti- |
| ELECTRICAL | | | cles |
| STIMULI | Photochromism | Reversible change in color | Inorganic photochromic |
| | | or darkening of photochro- | systems |
| | | mic system caused by ab- | Organic photochromic |
| | | sorption of ultraviolet or | systems (Photochromic |
| | | visible light | organic dyes) |
| | | | Organic-inorganic hybrid |
| | | | systems |
| | Thermochromism | Reversible change in color | Polymer-organic crystal |
| | | or darkening of thermo- | system (low molecular- |
| | | chromic system by heating | weight system or trans- |
| | | to different temperatures, | parent/opaque type) |
| | | heating and cooling, or | Dye complex system |
| | | heating and electrical field | (coloring/decoloring type) |
| | | application | Smectic liquid crystal |
| | | | system |
| DISPLAY | Liquid crystals | Changing the orientation of | Elastic LCD (liquid crys- |
| TECHNOLOGIES | | liquid crystalline molecules | talline elastomers) |
| BASED ON | | (molecular orientation) | Polymer-stabilized cho- |
| ELECTRICAL | | under an applied electrical | lestric LCD (bistable) |
| STIMULI | | field | Ferroelectric LCD (bista- |
| | | | ble) |
| | | | Fast response multista- |
| | | | ble LCD |
| | Organic/polymeric | Excitation of atomic struc- | OLED: organic light emit- |
| | light emitting di- | tures by electron an hole | ting diodes based on small |
| | odes | injection thereto | organic molecules |
| | | | PLED/LEP: polymeric |
| | | | light emitting diodes/light |
| | | | emitting polymers |
| | Suspended parti- | Polarization of dielectric | Liquid type |
| | cles | particles suspended in a | Film type (encapsulated |
| | | dielectric liquid under an | dispersed) |
| | | applied electric field chang- | |
| | | ing between light absorp- | |
| | | tion (random orientation) | |
| | | and light transmission | |
| | | (aligned orientation) states | |
| | Rotatable dichroic | Rotation of optical aniso- | Dichroic dipole dyes |
| | dipoles | tropic (dichroic) and electri- | Dichroic dipole particles |
| | | cally anisotropic (dipole) | dispersed and encapsu- |
| | | particles under an applied | lated in a plastic sheet |
| | | electrical field | (Gyricon) |
| | Electrophoresis | Movement of charged par- | Liquid film |
| | | ticles in a liquid under an | Microencapsulated |
| | | applied electric field | (e. ink) |
| | Electrochromism | A reversible and visible | Thin films of transition |
| | | change in transmittance | metal oxides (e.g. WO3, |
| | | and/or reflectance that is | MoO3, etc.) |
| | | associated with an electro- | Thin film of inherently |
| | | chemically induced oxida- | conductive polymers |
| | | tion-reduction reaction ef- | (e.g. polyanilines, polypyr- |
| | | fected by a small electric | roles, polythiophenes, |
| | | current at low dc potential | etc.) |
| | | | Others, including |
| | | | viologens, Prussian blue, |
| | | | metallopolymers, metal- |
| | | | phthalocyanines, etc. |

FIG. 4 schematically illustrates a realization of the electronic game card. The electronic circuit (410) is carried by a thin single sided flexible PCB (420) whereon the individual components for the gaming/lottery functions are surface mounted. The flexible PCB acts either as the base support for the whole lottery ticket or is attached to another flexible base carrier.

The electrical circuit (410) is patterned on the flexible PCB substrate (420). A control device (450), a battery (440) and a piezo electric speaker (430) is mounted on the circuitry using, for example, wire bonding or soldering.

In this example the electrodes have a lateral configuration, i.e. the display electrodes are situated side by side on the PCB substrate. In order to achieve a reflective background the display electrode areas (460) are pre-printed with a highly reflective ink (for example titanium dioxide). The active display ink (460), e.g. PEDOT:PSS, is printed on the reflective areas followed by the printed electrolyte system (470).

In this example mechanical push buttons are used, and distances (480) are printed/laminated at the push button electrode areas in order to secure the off state. By pressing on the outer surface of the game card, a conductive portion is lowered such that it provides electronic contact between two wires (490) in the push button electrode area.

Here, the top layer on the lottery ticket acts both as the carrier for the static print, and as the encapsulation layer for both the displays as well as the push button electrodes. This layer is arranged of a transparent foil e.g. PET, and a static print is applied on one side leaving transparent openings for the display elements. The push button contact areas are printed with e.g. Ag on the other side of the top layer. The top layer is thereafter laminated to the base substrate.

The invention has mainly been described above with reference to a number of explicitly disclosed embodiments. However, as is readily appreciated by a person skilled in the art, other embodiments than the ones disclosed above are equally possible within the scope of the invention, as defined by the appended patent claims.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise.

1. An electronic game card comprising:
a control device with processing capabilities for controlling a game,
a start device, operably connected to said control device, for activating the game;
a random value generator for generating a random data which determines the outcome of the game, which generator is operably connected to said control device;
a display device, operably connected to said control device, for visually indicating an outcome of the game; and
a flexible support made of a material selected from a group comprising paper, plastic and combinations thereof, whereon said control device, said start device, said display device and said random value generator are arranged.

2. An electronic game card according to claim 1, wherein said display is flexible.

3. An electronic game card according to claim 1, wherein the thickness of said game card is less than 2 mm.

4. An electronic game card according to claim 1, wherein said display device comprises means for generating at least two different colors.

5. An electronic game card according to claim 1, wherein said display comprises means for graphically illustrating the progress of the game.

6. An electronic game card according to claim 5, wherein said animation comprises a series of pictures.

7. An electronic game card according to claim 1, further comprising a power source, which is arranged on said support and operably connected to said control device.

8. An electronic game card according to claim 7, wherein said power source is selected from a group comprising batteries and solar cells.

9. An electronic game card according to claim 8, wherein said power source is flexible.

10. An electronic game card according to claim 1, further comprising an input device, being arranged on said substrate and operably connected to said control device, which input device is arranged to receive input from a player and forward said input to said control device.

11. An electronic game card according to claim 1, wherein said game is an instant lottery game.

12. An electronic game card according to claim 1, wherein said game is a probability game.

13. An electronic game card according to claim 1, wherein said random value generator is a pseudorandom number generator.

14. An electronic game card according to claim 1, wherein said support is formed as a sheet.

15. An electronic game card according to claim 1, further comprising encrypting means for generating a code using data generated by said random value generator.

16. An electronic game card according to claim 1, wherein the thickness of the card is less than 2 mm.

17. An electronic game card according to claim 14, wherein the surface of said sheet is smaller than 0.1 m².

18. An electronic game card according to claim 1, wherein said game card is a disposable game ticket.

19. An electronic game card according to claim 10, further comprising a display device arranged to visually displaying said betting information to the player.

20. An electronic game card according to claim 1, further comprising connecting means arranged for connecting said control device to an external, power source.

21. An electronic game card according to claim 20, wherein said external power source comprises the power source of a cellular phone.

22. An electronic game card according to claim 1, wherein the display is an electrochromic display.

23. An electronic game card according to claim 1, wherein said control device is an integrated circuit.

24. An electronic game card according to claim 1, further comprising circuitry of electrically conducting polymers.

25. An electronic game card according to claim 1, wherein said start device is a button.

26. An electronic game card according to claim 1, further comprising a loud speaker.

27. A method of operating an electronic game card, comprising a flexible support made of a material selected from the group comprising paper, plastic and combinations thereof, comprising the steps of:
activating a control device having processing capabilities for controlling a game, which control device is carried by said support of said game device;
generating random data by means of a random data generator carried by said support;
transmitting said generated random data to said control device;
determining at said control device, whether said data corresponds to a successful game;
displaying by means of a display device, carried by said support, the result of said determination.

28. A method of operating an electronic game card, comprising a flexible support made of a material selected from the group comprising paper, plastic and combinations thereof, comprising the steps of:
activating a control device having processing capabilities for controlling a game, which control device is carried by the support of said game device;
generating a group of random data by means of a random data generator carried by said support, which group of data represent successful outcomes of a game;
providing said control device with both result data representing an outcome of the game and said group of random data;
determining, at said control device, whether the outcome of the game is successful by comparing said result data to said group of random data;
displaying by means of a display device, carried by said support, the result of said determination.

29. A method according to claim 27, wherein said step of determining whether said data corresponds to a successful game, further comprises comparing said data to a list of data representing successful games.

30. An electronic game card according to claim 3, wherein the thickness of said game card is less than 1 mm.

31. An electronic game card according to claim 16, wherein the thickness of the card is less than 1 mm.

32. An electronic game card according to claim 2, wherein the display is an electrochromic display.
